(19) United States
(12) Patent Application Publication
(10) Pub. No.: US 2024/0144379 A1
(43) Pub. Date: May 2, 2024

(54) SYSTEMS AND METHODS FOR DECENTRALIZED CLAIMS PROCESSING

(71) Applicant: Change Healthcare Holdings, LLC, Nashville, TN (US)

(72) Inventors: Srilekha Akula, Fremont, CA (US); Andras L. Ferenczi, Scottsdale, AZ (US); Deas M. Richardson, VI, Mount Pleasant, SC (US)

(21) Appl. No.: 18/049,687

(22) Filed: Oct. 26, 2022

(51) Int. Cl. G06Q 40/08; G06F 16/93

(52) U.S. Cl. CPC G06Q 40/08; G06F 16/93; G06Q 2220/00

(57) ABSTRACT

In an embodiment, systems and methods storing claims on a DSP and a cryptographic ledger are provided. When a provider generates a claim for a medical service, the claim is encrypted using key exchanged between the provider and the payor. The encrypted claim is stored at the DSP at a DSP provided address. The encrypted claim and DSP provided address are stored on a cryptographic ledger as an NFT or other data structure. The payor may retrieve the DSP provided address from the ledger and may retrieve the encrypted claim from the DSP. The payor may decrypt the claim and may facilitate payment for the claim via a smart contract or may otherwise dispute the claim. At a later time, the provider (or payor) can use a zero-knowledge proof to prove that the claim was provided (or paid).

### BACKGROUND

Cloud based dropbox service providers (“DSP”) provide free or low cost storage for documents such as claims. However, drawbacks associated with such services include the inability or providers to easily switch or change DSPs, and the inability to provide proof that a document or claim was provided to the DSP.

Storing documents and claims on a distributed ledger provides proof that a claim or document was in fact provided, however, storage of documents on the distributed leger can be slow and expensive.

Accordingly, what is needed is system for storing claims and documents on a DSP with the proofs and other cryptographic guarantees provided by the distributed ledger.

### SUMMARY

In an embodiment, systems and methods storing claims on a DSP and a cryptographic ledger are provided. When a provider generates a claim for a medical service, the claim is encrypted using key exchanged between the provider and the payor. The encrypted claim is stored at the DSP at a DSP provided address. The encrypted claim and DSP provided address are stored on a cryptographic ledger as an NFT, for example. The payor may retrieve the DSP provided address from the ledger, and may retrieve the encrypted claim from the DSP. The payor may decrypt the claim and may facilitate payment for the claim via a smart contract, or may otherwise dispute the claim. At a later time, the provider (or payor) can use a zero-knowledge proof to prove that the claim was provided (or paid).

The systems and methods described herein provide at least the following advantages. First, because the distributed cryptographic ledger is used to only store identifiers of claims and addresses of claims in the DSP, the costs of storing the claims are minimized by storing the encrypted claims on the DSP, while benefits of the cryptographic ledger including proofs and attestation are achieved. Second, if the providers or payors decide to switch DSPs, only the addresses stored on the distributed leger for each claim needs to be updated. This allows providers and payors to easily switch between DSPs based on considerations such as cost or service level.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated herein and form part of the specification, illustrate a system and method for decentralized claims processing. Together with the description, the figures further serve to explain the principles of the system and method for decentralized claims processing described herein and thereby enable a person skilled in the pertinent art to make and use the system and method for decentralized claims processing.

FIG. 1 is an example environment for managing claims using storage providers and distributed ledgers;

FIG. 2 is an illustration of a method for generating and storing a claim using a storage provider and a distributed ledger;

FIG. 3 is an illustration of a method for receiving and processing a claim from a storage provider and a distributed ledger; and

FIG. 4 shows an example computing environment in which example embodiments and aspects may be implemented.

### DETAILED DESCRIPTION

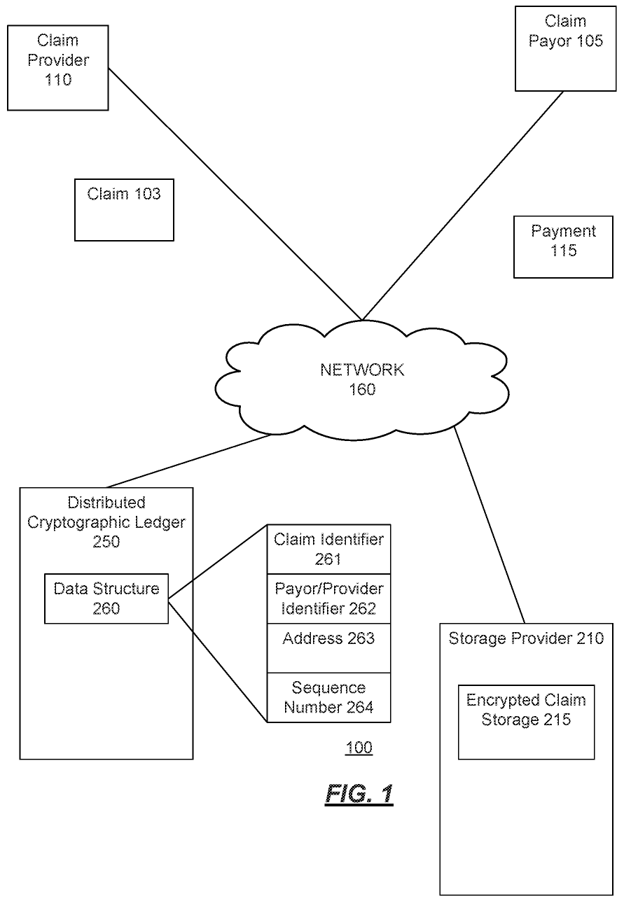

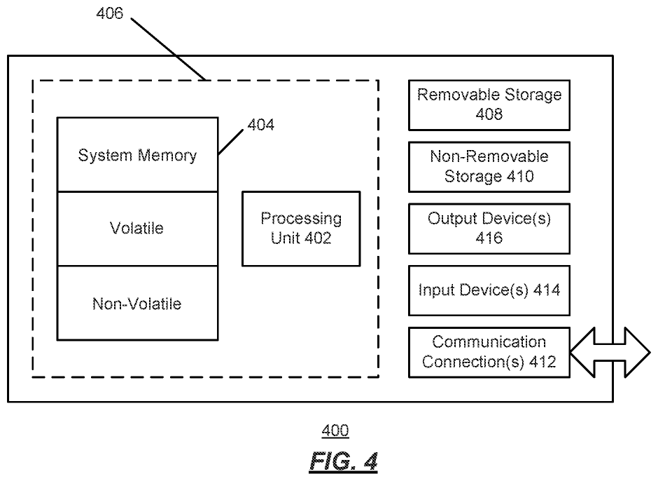

FIG. 1 is an example environment for managing claims using storage providers and distributed ledgers. As shown, the environment 100 may include one or more claim providers 110, one or more claim payors 105, one or more storage providers 210, and one or more distributed cryptographic ledgers 250 in communication through a network 160. The network 160 may include a combination of private networks (e.g., LANs) and public networks (e.g., the Internet). Each of the claim provider 110 and the claim payor 105 may be partially implemented by one or more general purpose computing devices such as the computing device 400 illustrated in FIG. 4.

The claim provider 110 may be a medical provider or any other entity that provides claims 103 to one or more claim payors 105. The claims 103 may be insurance claims, and in some embodiments, claims 103 related to medical services provided to a patient by the claim provider 110 or another entity. The claim payor 105 may include insurance companies, government entities, or any other entity that may pay claims 103 on behalf of patients or other entities that contract with the payor 105.

To provide for the efficient storage and to preserve the privacy of patients associated with the claims 103, the environment 100 may utilize both a storage provider 210 and a distributed cryptographic ledger 250. The storage provider 210 as used herein includes any entity that provides document storage services and includes dropbox storage providers (“DSP”) and/or cloud-based document storage providers. Example storage providers include iCloud, Google Drive, Box, and OneDrive. Each storage provider 210 may expose an API through which the claim providers 110 and claim providers 105 may write and read documents (e.g., claims 103) from the storage providers 210.

The distributed cryptographic ledger 250 is a record keeping system where transactions (or any data structure 260) can be recorded in blocks on the ledger 250. Examples of suitable legers 250 include blockchain.

The claim provider 110 may generate a claim 103 for a claim payor 105. The claim 103 may be associated with a medical service and may include a requested amount for the medical amount from the payor 105. Depending on the embodiment, the claim 103 may be formatted using the X12 transaction format. The claim 103 may be associated with a unique claim identifier such as a universal unique identifier (“UUID)”. Any method for generating a UUID may be used.

The claim provider 110 may encrypt the claim 103. In order to encrypt the claim 103, the claim provider 110 may generate a Diffie-Helman shared secret key using a public key of the claim payor 105 and a private key of the claim payor 105. The public key of the claim payor 105 may be provided by the payor 105 or retrieved from a registry of public keys. The claim 103 may be encrypted using the shared secret key. Other methods for encrypting a claim 103 may be used. In some embodiments, the shared key may be generated using the W3C DID specification.

In some embodiments, the claim provider 110 may gen the public key of the claim payor 105 from a decentralized identity provider. Alternatively, the claim provider 110 may get the public key of the claim payor from a smart contract associated with the claim provider 110 and the claim payor 105. The smart contract may be stored on the distributed cryptographic leger 250.

The claim provider 110 may generate what is known as a zero-knowledge proof for the claim 103. The zero-knowledge proof for the claim 103 may allow the claim provider 110 to prove to another party or entity that the claim 103 exists without having to provide any information about the contents of the claim 103. In some embodiments, the claim provider 110 may generate the zero-knowledge proof using Pedersen Commitments where the claim provider 110 selects a random value T and generates the zero-knowledge proof using a hash of the claim 103 and the random value T. The claim provider 110 may store the claim 103 locally along with the value T.

The claim provider 110 may determine the address of the storage provider 210 that will be used to store the encrypted claim 110. In some embodiments, the storage provider 210, or other entity, may have provided the address of the storage provider 210 to the claim provider 110. In other embodiments, the claim provider 110 may retrieve the address from a source such as the ledger 250. In these embodiments, the particular storage provider used may be changed simply by changing the address with the ledger 250.

After determining the address of the storage provider 210, the claim provider 110 may provide the encrypted claim 103 to the storage provider 210 using the address. Depending on the embodiment, the claim provider 110 may provide the claim 103 using a post command with the address of the storage provider 210, the encrypted claim 103, and the unique identifier of the claim 103. Other methods may be used. The storage provider 210 may store the claim 103 in encrypted claims storage 215.

Before allowing the claim provider 110 access to the encrypted claim storage 215, the storage provider 210 may first validate the claim provider 110. In some embodiments, the claim provider 110 may generate a hash-based authentication code (HMAC) using the public key of the provider 110 and the claim 103. The storage provider 210 may then validate the provider 110 using the HMAC and the public key of the claim provider 110 as provided by the identity service or smart contract between the claim provider 110 and claim provider 105. Alternatively, the storage provider 210 may validate the claim provider 110 using a list of entities that are permitted to access the encrypted claim storage 215.

After storing the encrypted claim 103 with the storage provider 210, the claim provider 110 may create and store a data structure 260 on the distributed cryptographic ledger 250 for the claim 103. The data structure 260 may be a non-fungible token (“NFT”), although other types of data structures 260 may be used. The data structure 260 may be created via the smart contract between the claim provider 110 and the claim payor 105, for example.

The data structure 260 may include a plurality of fields including, but not limited to, a claim identifier 261, a payor/provider identifier 262, and address 263, and a sequence number 264. Other fields may be supported.

The claim identifier 261 may uniquely identify the encrypted claim 103 that is stored by the storage provider 210. The claim identifier 261 may be the same UUID that was created by the claim provider 105.

The payor/provider identifier 262 may identify the entity (i.e., provider 110 or payor 105) who needs to take action with respect to the data structure 160. For example, where the data structure 260 relates to a new claim 103, the payor/provider identifier 262 may identify the claim payor 105. Where the data structure 260 relates to a disputed claim 105 or a request for more information about a claim 103, the payor/provider identifier 262 may identify the claim provider 110. Depending on the embodiment, the payor/provider identifier 262 may be the public key of the payor 105 or provider 110.

The address 263 may be the address of the storage provider 210 where the claim 103 is stored. The address 163 may be an IP address or some other identifier that can be used to locate the storage provider 210.

The sequence number 264 may be used to identify subsequent actions or responses with respect to the data structure 260. For example, when a claim 105 is first created the corresponding sequence number 264 may initially sent to 0 (or 1 in other embodiments). Each subsequent action taken with respect to the claim 105 may increment the sequence number 264 by one.

After the claim provider 105 stores the data structure on the cryptographic ledger 250, the corresponding claim payor 105 may become aware of the data structure 260 and the associated claim 103. For example, the claim provider 105 may monitor the ledger 150 for data structures 160 that include an identifier 262 (e.g., public key) of the payor 105. Alternatively or additionally, the claim provider 105 (or other entity) may send a message to the payor 105 that a new data structure 260 and claim 103 have been added for the payor 105.

After determining that a claim 103 exists, the claim payor 105 may retrieve the public key of the claim provider 110 associated with the claim 103 and may generate the shared key using the public key of the claim payor 110 and the public key of the claim provider 105 as described above. The claim payor 105 may then use the address 263 of the storage provider 210 and the claim identifier 261 from the data structure 260 to retrieve the encrypted claim 103. For example, the claim payor 105 may retrieve the encrypted claim 103 using a get command along with the address 263 of the storage provider 210 and the claim identifier 261.

In some embodiments, before retrieving the encrypted claim 103 from the encrypted claim storage 215, the claim payor 105 may first be validated by the storage provider 210. Similar to the claim provider 110, the claim payor 105 may generate a HMAC using its public key and the request for the encrypted claim 103. The storage provider 210 may then validate the payor 105 using the HMAC and the public key of the claim payor 105 as provided by the identity service or smart contract between the claim provider 110 and claim provider 105.

After retrieving the encrypted claim 103, the payor 105 may decrypt the claim 105 using the shared secret key. If the payor 105 agrees to pay the claim 105, then the payor 105 may cause a payment 115 to be made to the claim provider 110. Depending on the embodiment, the payment 115 may be made through the associated smart contract using bitcoin or other cryptocurrency associated with the ledger 250. The claim payor 105 may further update the data structure 260 and/or the storage provider 210 to indicate that a payment 115 has been made. For example, the payor 105 may store an encrypted receipt of the payment 115 on storage provider 210 using the shared secret key as described above and may update the data structure 260 to reflect the payment 115. For example, the payor 105 may change the identifier 262 to that of the provider 110 and may update the sequence number 264.

In the event that the claim payor 105 needs more information about the claim 103 from the provider 110, the payor 105 may similarly encrypt a request for information, store the encrypted request with the storage provider 210 and may update the data structure 260 to reflect the request for more information. The payor 105 and provider 110 may exchange information back and forth via the storage provider 210, and may continue to update the data structure 260 at each iteration until the claim 103 can be paid or the payor 105 rejects the claim 103 altogether. When the claim 103 is rejected, the payor 105 may destroy the associated data structure 260.

At a later time, an auditor or other entity may desire to audit or validate a claim 103 between the claim provider 110 and the claim payor 105. In addition, the encrypted claim 103 may no longer be stored or available from the storage provide 210. To prove that the claim 103 did exist, the claim provider 110 (or other participant) may provide the claim 103 (or hash of the claim 103) and the random T that was used to generate the zero-knowledge proof described above. The auditor may then retrieve the zero-knowledge proof from the smart contract associated with the provider 110 and payor 105. The auditor may then verify that the zero-knowledge proof matches Commit(hash(claim 103), T). If so the claim 103 is validated, otherwise the claim 103 is not validated.

In some embodiments, penalties regarding claim 103 payments 103 and submission may be provided by the smart contract associated with the claim provider 110 and the claim payor 105. Penalties may include penalties related to the timely payment of claims 103 by the provider. For example, the claim payor 105 may maintain an escrow account with the smart contract. If a claim 103 has not been acted on or paid after an agreed upon amount of time since the claim 103 is submitted by the claim provider 110, the smart contract may automatically transfer a penalty from the escrow of the claim payor 105 to the claim provider 110. Alternatively, the smart contract may automatically transfer a complete or partial payment 115 for the claim 103 from the escrow of the claim payor 105 to the claim provider 110.

With respect to the claim provider 110, the smart contract may penalize the claim provider 110 for submitting duplicate or malformed claims 103. For example, if the claim provider 110 submits a claim 103 that was already submitted, the smart contract may automatically transfer a penalty from the escrow of the claim provider 110 to the claim payor 105. Similarly, if the claim provider 110 provides a claim 103 with missing fields or metadata, the smart contract may assess a penalty.

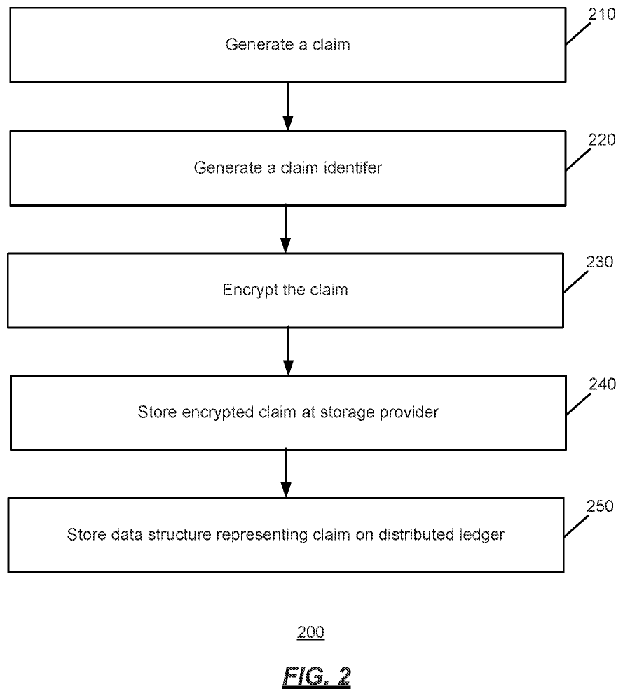

FIG. 2 is an illustration of a method 200 for generating and storing a claim 103 using a storage provider 210 and a distributed ledger 250. The method 200 may be performed by a claim provider 110.

At 210, a claim is generated. The claim 103 may be generated by the claim provider 110. The claim 103 may be a claim 103 for a medical service. The claim 103 may be associated with a claim payor 105 who is obligated to pay the claim 103 on behalf of a patient that received the medical service. The obligation of the claim payor 105 to the patient may be governed by a smart contract.

At 220, a claim identifier is generated. The claim identifier may be generated by the claim provider 110. The claim identifier may uniquely identify the claim 103 to both the claim payor 110 and the claim payor 105.

At 230, the claim is encrypted. The claim 103 may be encrypted by the claim provider 110 using at least a public key of the claim payor 105. In some embodiments, the claim provider 110 may encrypt the claim 103 by generating a shared secret key using the public key of the claim provider 110 and the public key of the claim payor 105.

At 240, the encrypted claim is stored. The encrypted claim 105 may be stored by the claim provider 110 on the encrypted claim storage 215 of the storage provider 210. The storage provider 210 may be a dropbox storage provider, for example.

At 250, a data structure representing the claim is stored. The data structure 260 representing the claim 103 may be stored by the claim provider 110 on the distributed cryptographic leger 250. The data structure 260 may be an NFT and may include the claim identifier, an identifier of the claim payor 105, (e.g., public key), and an address 263 of the storage provider 210 where the encrypted claim 103 is stored.

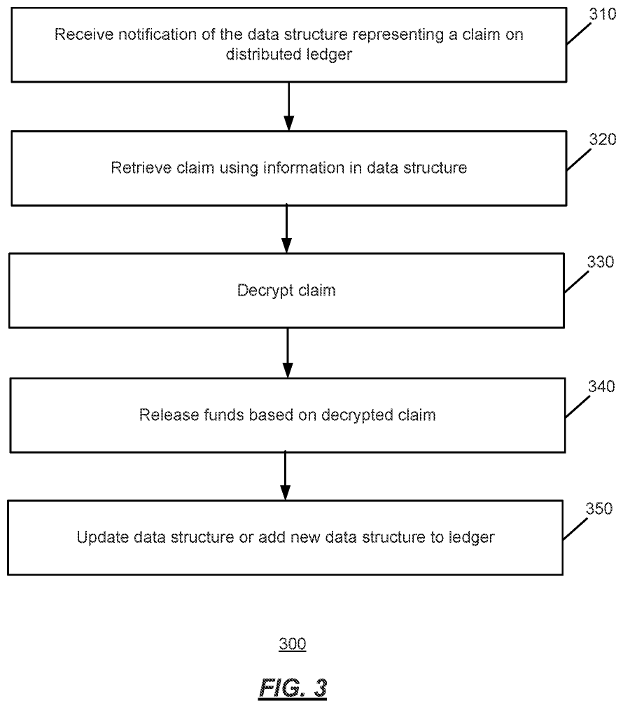

FIG. 3 is an illustration of a method for receiving and processing a claim 103 from a storage provider 210 and a distributed ledger 250. The claim 103 may be processed by a claim payor 105.

At 310, a notification of the data structure representing a claim of a distributed leger is received. The notification may be provided by the distributed leger 250 to the claim payor 105 in response to a data structure 260 with an identifier 262 of the payor 105 (e.g., public key) being added to the ledger 150. The data structure 260 may also include a claim identifier 261, and address 263 of the storage provider 210 that stores the claim 103.

At 320, the claim is retrieved using information from the data structure. The encrypted claim 103 may be retrieved from the storage provider 210 by the claim payor 105. In some embodiments, the claim payor 105 may retrieve the data structure 260 from the distributed ledger 250 and may get the address of the storage provider 210 from the address 263 field of the data structure 260. The claim payor 105 may retrieve the encrypted claim 103 using the address from the storage provider 210.

At 330, the claim is decrypted. The claim 103 may be decrypted by the claim payor 105. The claim 103 may be decrypted using at least a public key of the claim provider 110. In some embodiments, the claim payor 105 may decrypt the claim 103 using the shared secret key generated using the public key of the claim provider 110 and the public key of the claim payor 105. Other method may be used.

At 340, funds are released based on the decrypted claim. The funds may be released by the claim payor 105 as a payment 115. In some embodiments, the payment 115 may be made using a smart contract associated with the claim provider 110 and the claim payor 105.

At 350, the data structure is updated, or a new data structure is added to the distributed leger. After making the payment 115, the claim payor 105 may update the data structure 260 associated with the claim 103 to reflect the payment 115 or may add a new data structure 260 to the distributed cryptographic layer 250. The new data structure 260 or updated data structure 260, may include an updated sequence number 264, an identifier of the provider 262, and an address 263 where an encrypted receipt or proof of the payment 115 can be retrieved from the storage provider 210.

FIG. 4 shows an example computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an example system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by the device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communication connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although example implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
generating a claim by a provider for a payor;
generating a claim identifier for the claim by the provider;
encrypting the claim by the provider using at least a public key of the payor;
storing the encrypted claim at a document storage provider by the provider; and
storing a data structure representing the claim on a distributed ledger by the provider, wherein the data structure comprises an identifier of the claim, an identifier of the payor, and an address of the document storage provider.

2. The method of claim 1, wherein the data structure is an NFT.

3. The method of claim 1, further comprising generating a zero-knowledge proof of the claim.

4. The method of claim 1, further comprising:
receiving a notification of the data structure on the distributed ledger by the payor;
using the address of the document storage provider and the identifier of the claim, retrieving the encrypted claim from the document storage provider;
decrypting the encrypted claim by the provider; and
releasing funds to the payor based on the decrypted claim.

5. The method of claim 4, wherein the claim is associated with a smart contract and further comprising releasing the funds to the provider via the smart contract.

6. The method of claim 1, wherein encrypting the claim by the provider using at least the public key of the payor comprises:
generating a shared secret key using a public key of the provider and the public key of the payor; and
encrypting the claim using the shared secret key.

7. The method of claim 1, wherein the claim is a medical claim.

8. A system comprising:
at least one computing device; and
a computer-readable medium with computer-executable instructions stored thereon that when executed by the at least one computing device cause the system to:
generate a claim for a payor;
generate a claim identifier for the claim;
encrypt the claim using at least a public key of the payor;
store the encrypted claim at a document storage provider; and
store a data structure representing the claim on a distributed ledger wherein the data structure comprises an identifier of the claim, an identifier of the payor, and an address of the document storage provider.

9. The system of claim 8, wherein the data structure is an NFT.

10. The system of claim 8, further comprising generating a zero-knowledge proof of the claim.

11. The system of claim 8, further comprising computer-executable instructions stored thereon that when executed by the at least one computing device cause the system to:
receive a notification of the data structure on the distributed ledger;
use the address of the document storage provider and the identifier of the claim, retrieving the encrypted claim from the document storage provider;
decrypt the encrypted claim; and
release funds to the payor based on the decrypted claim.

12. The system of claim 11, wherein the claim is associated with a smart contract and further comprising releasing the funds to a provider via the smart contract.

13. The system of claim 8, wherein encrypting the claim using at least the public key of the payor comprises:
generating a shared secret key using a public key of a provider and the public key of the payor; and
encrypting the claim using the shared secret key.

14. The system of claim 8, wherein the claim is a medical claim.

15. A non-transitory computer-readable medium with computer-executable instructions stored thereon that when executed by at least one computing device cause the at least one computing device to:
generate a claim for a payor;
generate a claim identifier for the claim;
encrypt the claim using at least a public key of the payor;
store the encrypted claim at a document storage provider; and
store a data structure representing the claim on a distributed ledger wherein the data structure comprises an identifier of the claim, an identifier of the payor, and an address of the document storage provider.

16. The non-transitory computer-readable medium of claim 15, wherein the data structure is an NFT.

17. The non-transitory computer-readable medium of claim 15, further comprising generating a zero-knowledge proof of the claim.

18. The non-transitory computer-readable medium of claim 15, further comprising computer-executable instructions stored thereon that when executed by the at least one computing device cause the system to:
receive a notification of the data structure on the distributed ledger;
use the address of the document storage provider and the identifier of the claim, retrieving the encrypted claim from the document storage provider;
decrypt the encrypted claim; and
release funds to the payor based on the decrypted claim.

19. The non-transitory computer-readable medium of claim 18, wherein the claim is associated with a smart contract and further comprising releasing the funds to a provider via the smart contract.

20. The non-transitory computer-readable medium of claim 15, wherein encrypting the claim using at least the public key of the payor comprises:
generating a shared secret key using a public key of a provider and the public key of the payor; and
encrypting the claim using the shared secret key.
